(19) United States
(12) Patent Application Publication
(10) Pub. No.: US 2008/0031433 A1
(43) Pub. Date: Feb. 7, 2008

(54) SYSTEM AND METHOD FOR TELECOMMUNICATION AUDIENCE CONFIGURATION AND HANDLING

(76) Inventors: Dustin Kenneth Sapp, Fishers, IN (US); Robert Andrew Compton, Germantown, TN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/834,244

(22) Filed: Aug. 6, 2007

Related U.S. Application Data
(60) Provisional application No. 60/835,540, filed on Aug. 4, 2006.
(60) Provisional application No. 60/835,541, filed on Aug. 4, 2006.
(60) Provisional application No. 60/850,571, filed on Oct. 10, 2006.

(51) Int. Cl. H04M 11/00

(52) U.S. Cl. 379/92.03

(57) ABSTRACT

Disclosed is a dynamic telecommunication configuration and management service. The service allows an organizer to initiate a conference, such as a telephone conference or virtual meeting, or plurality of individual communication sessions by selecting a profile of a desired audience. The service then selects a proper number of users from its database and connects to them at the appropriate time in the appropriate fashion in order to approximately meet the profile desired by the host. In a further form, the service monitors the conference once created and makes necessary changes to ensure that the connected audience remains in compliance with the specified profile. In another preferred form, the host is provided with a real-time interest level as perceived from the audience of connected users. The host may utilize this interest level to dynamically alter the course of the conference in either substance or form in order to maintain a higher level or user interest. In yet another preferred form, once connected, a user may be prompted with the option to be transferred to the telephone line of an entity of interest.

### CROSS REFERENCE TO RELATED APPLICATIONS

The present application claims the benefit of U.S. Provisional Patent Application Ser. No. 60/835,540 filed Aug. 4, 2006 entitled “System and Method for Monitoring Real-Time Conferencing and Dynamically Adjusting Content”, U.S. Provisional Patent Application Ser. No. 60/835,541 filed Aug. 4, 2006 entitled “System and Method for Providing Contact Branching from a Communication” and U.S. Provisional Patent Application Ser. No. 60/850,571 filed Oct. 10, 2006 entitled “System and Method for Dynamic Audience Configuration” all of which are hereby incorporated by reference in their entirety to the extent not inconsistent.

### FIELD OF THE INVENTION

The present invention generally relates to telecommunication systems and methods as well as to customized telecommunication sessions. More particularly, but not exclusively, the present invention pertains to a system and method for connecting to an audience of users meeting a predetermined profile.

### BACKGROUND

The impact and efficiency of survey information and other forms of feedback can be significantly increased if received from a pre-selected target audience. In addition, advertising and promotional activity can achieve improved success when presented to the appropriate audience. The success of any feedback or advertising campaign requires that the message reach and the feedback come from the target audience. Generally, these messages are targeted for one or more segments of a population, with large amounts of money spent on determining who the target audience is and how to reach them.

Typically, prior to launching a new product, companies attempt to gauge its success by presenting the products to focus groups. These focus groups consist of a wide range of users who have used similar products. In addition, during a given advertising campaign, it is helpful to measure the response of the target audience to certain advertisements and promotions. Likewise, after a given advertising campaign, companies often analyze the advertising campaign to confirm that the advertising messages reached the target audience. For instance, it is often the case that feedback is desired when determining whether to modify the product or discontinue it altogether. Additionally, the method of marketing may be selected based upon user interest levels with respect to several different types of advertising or presentation.

In order for an audience, such as a focus group, to be assembled, a large number of hours must be spent and travel arrangements made. In addition, it is practically impossible for this to take place in a short period of time, as would often be beneficial. As such, there exists for a method and apparatus for automatically creating a telecommunication session with a set of users which represent any set of criteria specified, such as users who have purchased similar products or have received and used the subject product. A further need exists for a method and apparatus for evaluating the reaction of an audience to presented content in real-time. Yet another need exists for maintaining the audience of a specific profile once established. A still further need exists for branching users to enable them to deliver messages to outside entities. Finally, a need exists for a method and apparatus for generating user interest indicators which are readily viewable by the marketing team behind a product in order to better understand its success/failure.

### SUMMARY

Various technologies and techniques are disclosed for configuring and carrying out an electronic conference. In one embodiment a telecommunication service receives a requested audience profile from a host or sponsoring entity. Preferably, the requested audience profile includes demographic characteristics of an audience, such as percentages or quantities, in addition to a total number of desired participants. In one form, when the telecommunication session is about to begin in the form of a conference, the service automatically connects a plurality of users to the conference such that their combined profile meets the requested audience profile. In an alternate form, the users are connected to individually through outbound calls in individual telecommunication sessions. In one alternate embodiment, the users may be connected via streaming content to a computer or by using web chats. In a further form, the service monitors the profile of the currently connected audience throughout the conference and may add or remove users at any time to ensure the connected audience profile maintains its requested characteristics.

In another embodiment, the service allows a user to be connected to an entity of interest, such as by using a dynamically selected telephone number. In an alternate form, the user may provide a message for delivery by the service to an entity of interest in a variety of different forms, such as voicemail or e-mail.

In yet another embodiment, the service provides a perceived interest level which indicates the interest level of one or more users connected to the conference. Preferably, the interest level is determined as a function of the audio stream provided by each user. In a further form, the conference may be split into smaller conferences based upon the interest level of the users to maximize overall user interest in a variety of different topics.

This summary is provided to introduce a selection of concepts in a simplified form that are described in further detail in the detailed description and drawings contained herein. This summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one implementation.

FIG. 2 is flowchart illustrating the process for receiving a plurality of criteria which define the target profile of a desired audience initiating a conference matching that profile.

FIG. 3 is a logical plan view of a target profile and a list of users according to one embodiment of the present invention.

FIG. 4 is a graphical view of a measure indicating the compliance of the audience profile to a target profile over time.

FIG. 5 is a graphical view of a measure indicating the compliance of the audience profile to the specific characteristic of female user percentage over time.

FIG. 6 is a graphical view of a measure indicating the compliance of the audience profile to the specific characteristic of percentage of users with children over time.

FIG. 7 is a graphical view of a measure indicating the compliance of the audience profile to the specific characteristic of total percentage of minority user over time.

FIG. 8 is flowchart illustrating the process for monitoring a user audio stream to determine a user interest level in one aspect of the present invention.

FIG. 9 is a graphical view of a collective user interest measure in correlation with the content presented during the conference over time in one embodiment of the present invention.

FIG. 10 is a logical plan view of the interaction between a number of conferences according to one embodiment of the present invention.

FIG. 11 is flowchart illustrating the process for branching a user to allow delivery of a message to an entity of interest in one aspect of the present invention.

### DESCRIPTION OF THE SPECIFIC EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Disclosed is a dynamic electronic telecommunication configuration and management service operated by a service host in conjunction with an organizer and host. The service may establish either an electronic conference or a plurality of individual outgoing telephone calls as telecommunication sessions. The organizer of the telecommunication session(s) may be an individual, an organization, or some other entity of interest. It shall be appreciated that the host of a telecommunication session may include more than one individual associated with the organizer, depending upon the complexity desired. The service allows an organizer to initiate one or more telecommunication sessions, such as a telephone conference, plurality of individual telecommunication sessions, web chat room, or virtual meeting, which is commonly known to one of skill in the art. The telecommunication sessions may include individual users connected to the host through a variety of different networks such as the PSTN, Internet, or mobile data networks using a variety of different devices such as standard telephones, digital telephones, mobile telephones, or computers, to name just a few representative examples. In the case of telephones, the user may dial into the conference at a specified time, or the user may receive a call inviting the user to participate. In other forms, such as when the user is connected via a computer, the user may receive an e-mail or instant message inviting them to join the conference, such as via a hyperlink.

In a preferred form, the host selects the profile of a audience they would like to connect to. The profile may include demographics, previous purchasing history, or any other known information. The service then selects a proper number of users from its database and connects to them at the appropriate time in order to approximately meet the profile desired by the host. For example, a host may wish to schedule a conference of at least 500 users in which the audience includes 75% female participants, at least 50% of which are stay at home housewives and at least 25% of whom are living in a household with a combined income in excess of $75,000. Alternatively, a host may wish to initiate an outgoing telephone survey of at least 500 users in which the audience includes 80% male participants, at least 50% of which are retired. In exchange for their participation, users may be compensated or offered benefits such as free products, discounts, or otherwise.

In another preferred form, the host is provided with a real-time interest level as perceived from the audience of connected users. In one form, the host may utilize this interest level to dynamically alter the course of the conference in either substance or form in order to maintain a higher level of user interest. In an alternate form, the user interest level may simply be recorded as feedback, such as in response to an announcement played in an outgoing phone call.

In yet another preferred form, a user may be called by the service and prompted with the option to be transferred to the telephone line of an entity of interest. Alternatively, a user connected to the conference may be prompted with the same option. For example, an outbound call may be placed to a user and the user may be asked if they would like to speak to their Congressman's office. The service then places another outbound call to the proper number of the connected user's Congressman's office, which is dynamically selected based upon user supplied information, and the two calls are connected. In a further form, the user may be returned to the service upon completion of the branched call. Alternatively, a message may be received from the user for processing and delivery to the entity of interest, such as by voicemail or e-mail.

### System Architecture

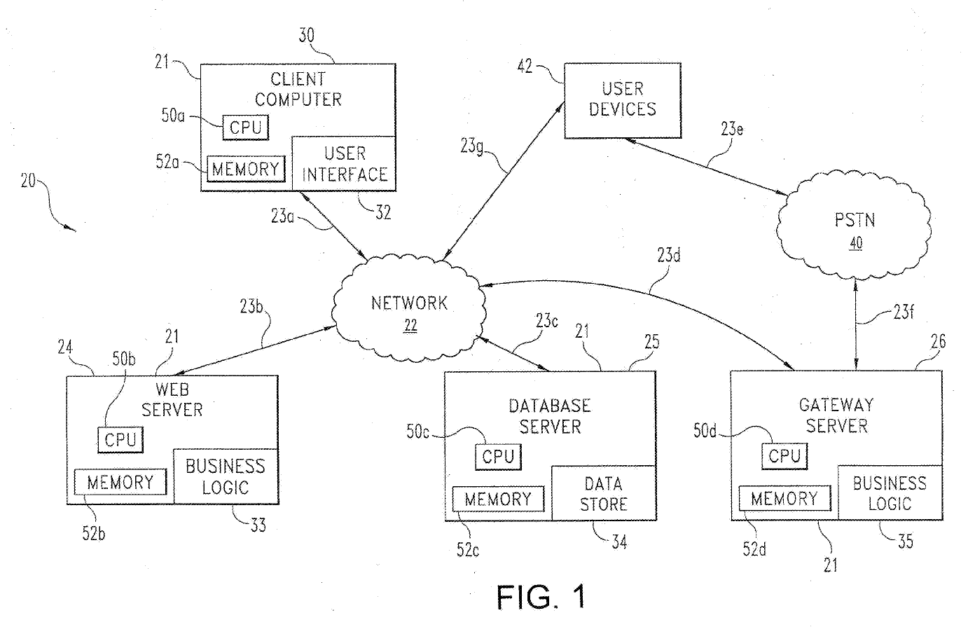

Turning to FIG. 1, a diagrammatic view of computer system 20 suitable for use in one embodiment of the present invention is shown. Computer system 20 includes computer network 22. Computer network 22 couples together a number of computers 21 over network pathways 23a-23d. Public switched telephone network 40 couples together Gateway Server 26 and user devices 42 over pathways 23e-23f. In one form, computers 21 may also be connected to user devices 42 through network 22 via network pathway 23g, such as when the user devices are VoIP endpoints or other digital communication device. Pathways 23 may also be traditional PSTN connections, digital lines (such as T1, T3, OC3), or any other transmission medium suitable for carrying content, such as a wireless or cellular network. It shall be appreciated that user devices 42 may be of varying types located in geographically distinct remote locations and that the system 20 allows the connection of multiple user devices 42 of varying types to be connected to Gateway Server 26, or the system 20 in general, concurrently.

More specifically, system 20 includes several servers, namely Web Server 24, Database Server 25, and Gateway Server 26. System 20 also includes a client computer 30. While computers 21 are each illustrated as being a server or client, it should be understood that any of computers 21 may be arranged to include both a client and server. Furthermore, it should be understood that while four computers 21 are illustrated, more or fewer may be utilized in alternative embodiments. In particular, it shall be appreciated that a large number of client computers, such as client computer 30, may be in use within system 20 for performing operations such as allowing a host entity to configure/manage or individual users to connect to a telecommunication session via Web Server 24 and/or Gateway Server 26.

Turning to implementation specifics, in the illustrative embodiment, computers 21 include one or more processors or CPUs (50a, 50b, 50c and 50d respectively) and one or more types of memory (52a, 52b, 52c and 52d respectively). Each memory 52a-d preferably includes a removable memory device. Each processor 50a-50d may be comprised of one or more components configured as a single unit. Alternatively, when of a multi-component form, a processor 50a-50d may have one or more components located remotely relative to the others. One or more components of each processor 50a-50d may be of the electronic variety defining digital circuitry, analog circuitry, or both. In one embodiment, each processor 50a-50d is of a conventional, integrated circuit microprocessor arrangement, such as one or more PENTIUM 4 or XEON processors supplied by INTEL Corporation of 2200 Mission College Boulevard, Santa Clara, Calif. 95052, USA.

Each memory 52a-52d (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown, in one embodiment each computer 21 is coupled to a display and/or includes an integrated display. Computers 21 may be of the same type, or a heterogeneous combination of different computing devices. Likewise, displays may be of the same type, or a heterogeneous combination of different visual devices. Although not shown, each computer 21 may also include one or more operator input devices such as a keyboard or mouse to name just a few representative examples. Also, besides a display, one or more other output devices may be included such as a printer. As such, various display, input and output device arrangements are possible.

Computer network 22 can be in the form of a wireless or wired Local Area Network (LAN), Municipal Area Network (MAN), Wide Area Network (WAN), such as the Internet, a combination of these, or such other network arrangement as would occur to those skilled in the art. In a further form, several computers 21, such as Web Server 24, Database Server 25, and Gateway Server 26 may be coupled together by a secure portion of network 22 while remaining connected to client computer 30 via an unsecured portion of network 22. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations where Web Server 24 is configured to host application business logic 33 for an electronic telecommunication management service, Database Server 25 is configured to store user profile information associated with end users, and client computer 30 is configured for providing a user interface 32, for allowing a host entity to interact with the service, such as to initiate, monitor, and/or manage an set of telecommunication session. It shall be appreciated that in alternate forms client computer 30 may be any web-enabled device, such as a PDA, Blackberry, or mobile phone, to name just a few illustrative examples. Furthermore, user interface 32 of client computer 30 may be an installable application, such as one that communicates with Web Server 24, browser-based, and/or embedded software, to name a few non-limiting examples. In one embodiment, software installed locally on client computers 30 is used to communicate with Web Server 24. In another embodiment, Web Server 24 provides HTML pages, data from web services, and/or other Internet standard or company proprietary data formats to one or more client computers 30 when requested. One of ordinary skill in the art will recognize that the term Web Server 24 is used generically for purposes of illustration and is not meant to imply that network 22 is required to be the Internet.

Database Server 25 includes data store 34 which maintains a collection of user information which includes individual listing of the users who are participating in a telecommunication session. Associated with each user may be a collection of registration information which is preferably provided as a prerequisite to entering a conference. Portions of this information may have been obtained as a result of prior participation by the user, may have been entered by the user during a sign-up phase immediately prior to the present session, or may have been provided by the organizer or a third party. This information may include the user's name, age, address, income, education level, interests, prior purchasing data, marital status, or other valuable information, such as demographic information. Preferably, a portion of the information, such as the user's regional location, may be derived from the user's telephone number, IP address, or the like.

Gateway Server 26 includes business logic 35 and associated hardware allowing operation as a predictive dialer for placing outbound calls to a plurality of users and/or an answering service for directing inbound calls to an existing conference. In one form Gateway Server 26 may initiate a digital communication session with a selected subset of user devices 42 via network 22. In an alternate form Gateway Server 26 may initiate an analog communication session with any of user devices 42 over the PSTN 40. Depending upon the particular arrangement of system 20, each of user devices 42 may be a traditional analog telephone, a mobile telephone, such as one implementing GSM or CDMA technology, or a digital telephone, such as a VoIP phone. It shall be appreciated that a large number of user devices 42 will be included in use of system 20, but that only one collective whole has been shown to preserve clarity. Further, it shall be appreciated that the types of user devices connected to system 20 need not be of the same type, but that digital, analog, and other technologies may be accommodated simultaneously or sequentially.

Typical applications of system 20 would include three servers, such as Web Server 24, Database Server 25, and Gateway Server 26, but it will be appreciated by those of ordinary skill in the art that the one or more features provided by those servers could be provided by a single computer or varying other arrangements of computers at one or more physical locations and still be within the spirit of the invention.

### Audience Configuration

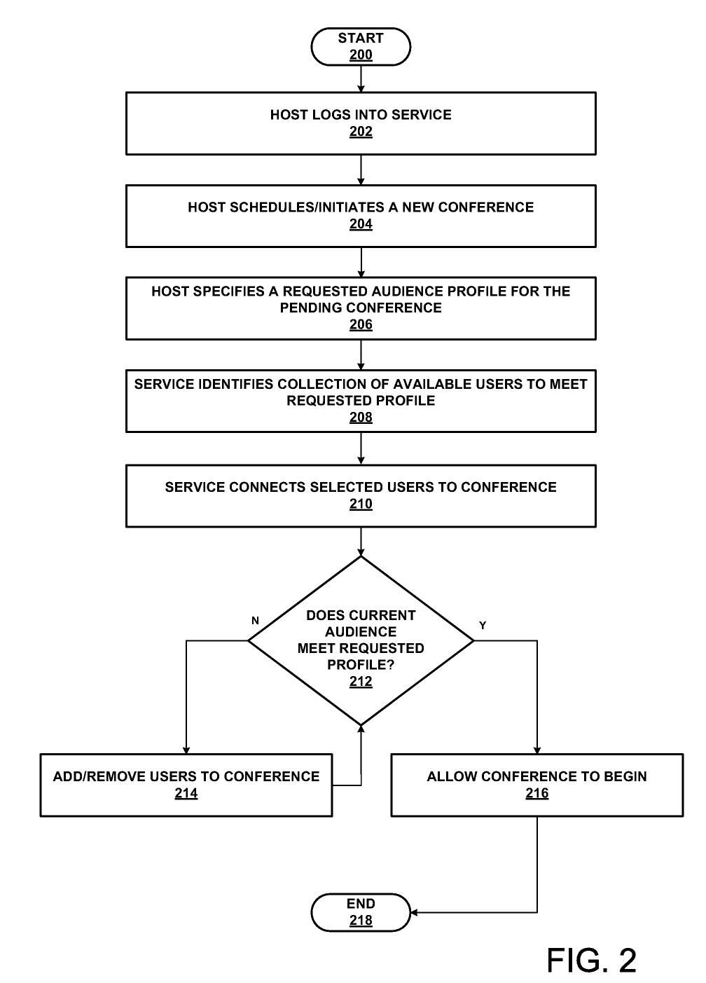

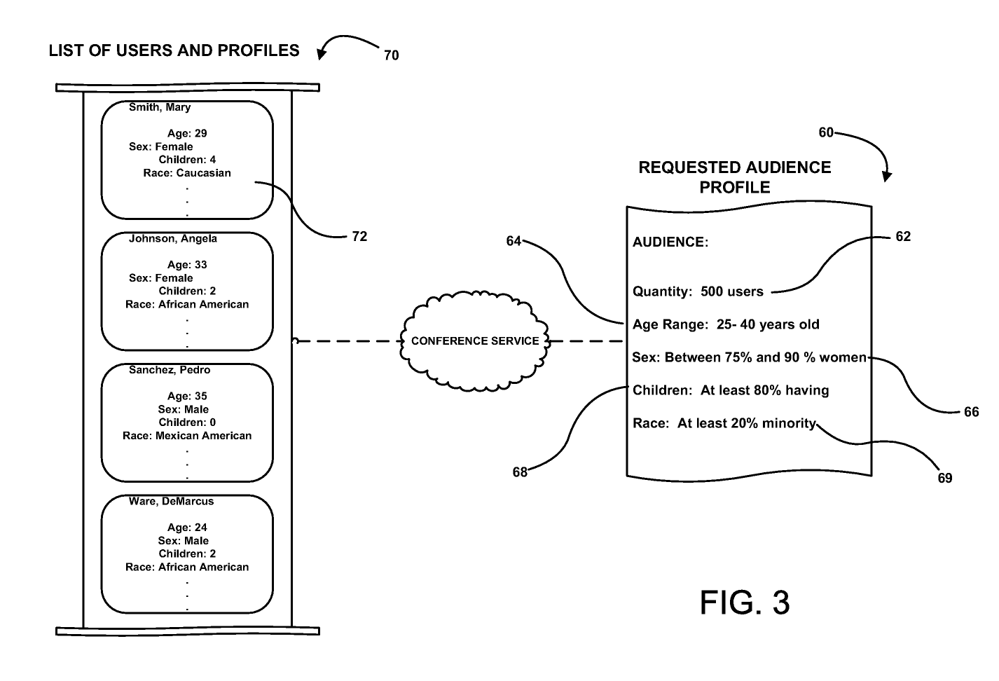

Turning to FIG. 2 and FIG. 3, with continued reference to FIG. 1, the process for receiving a plurality of criteria which define the target profile of a desired audience from a host and subsequently initiating a telecommunication session with an audience which meets the established criteria is shown. It shall be appreciated that this example is illustrated in the form of a conference, but the principles may be easily applied to other forms such as to the creation of an audience of individual users each connected in individual telecommunication sessions at various times.

The process begins at start point 200 with the host logging in to the service (stage 202), such as by using client computer 30. A host may log in using a pre-established account or some other method known in the art. In a preferred form, the client computer 30 acts as a hosting station in conjunction with a microphone and allows the host to easily control the progress of the conference, view the information obtained from the users, and optionally manage other features. Once logged in, the host initiates a new conference (stage 204), such as by scheduling a conference at a specified time in the future, or by configuring a conference for immediate creation. The host then provides a requested audience profile 60 for the pending conference to the service (stage 206). For purposes of illustration, the requested audience profile may include a quantity of participants 62, age range 64, gender percentage 66, percentage that are parents 68, or percentage of one or more ethnic backgrounds 69 to name just a few representative examples. The host may also specify a target number or percentage of the audience having a specific characteristic. Additionally, another number or percentage may be expressed as a floor, ceiling, or a target range for another specified characteristic of the requested audience. Further characteristics may be included as known or determined by the service about users, such as buying habits, previous purchasing information, household income, product or service experience, etc. It shall be appreciated that any combination of the numerous characteristics or demographics which may be requested from the user, provided by the host, or acquired by the service may make up a requested audience profile 60 in a number of different formats.

Once the service has received the requested audience profile 60 from the host, the conference service identifies a list of available users 70 who collectively meet the requested audience profile (stage 208). The list of available users 70 may be created using a simple iterative selection algorithm, through random placement and replacement, through algorithms, or by any other suitable method known to one of skill in the art. In an alternate form, the service may present a potential configuration to the host for approval in the event that a specific requested profile cannot be met. Additionally, the service may perform conflict checking to validate the profile 60 prior to fulfillment, such as in the event the profile specifies an impossible configuration, such as over 50% female and over 50% male. The illustrated list of users 70 includes associated user profiles, such as profile 72, indicating a number of characteristics known about the selected user. Once the list 70 is created and the scheduled time for the conference approaches, the service begins connecting to the selected users (stage 210) at their associated user device using Gateway Server 26.

At this point, the service collects the characteristics of the connected audience, such as by using user profile 72 stored in data store 34, and determines if they satisfy the requested audience profile 60 submitted by the host (stage 212). If the audience meets the requested profile 70, then the service allows the conference to begin (stage 216). Alternatively, if the audience does not meet the requested profile 70, the service adds or removes audience members (stage 214) in order to bring the audience into compliance. In a further form, as will be described below, the service may also monitor the state of the audience beyond this point to ensure that the profile of the audience remains in compliance with the target profile should the host desire.

In an alternate embodiment, the list of users 70 may be a list of connected users built just prior to the scheduled time for the conference. In this embodiment, the users may be added to the list only after they are connected to the conference and the service may select and attempt to connect additional users until the requested audience profile is met. In this form, when the service connects a disproportionately high percentage of users of one type, the system places additional users of the type in a waiting queue or thanks them for their response but informs them that the conference capacity has been met. In response to a lack of participation by users having a specific characteristic, the system may send out a number of additional invitations to attempt to spur additional participation by users having the lacking characteristic. In one further form, the system may also increase the reward or incentive offered to the users who meet the deficient characteristics of the audience to promptly meet the need.

Once the audience connected to the conference reaches the predetermined profile the host may initiate the conference. Similar to other conferencing technology known in the art, the service is able to provide web content, such as a series of slides, to supplement other forms of communication, such as a live audio, video, and/or text feed. Additionally, users are able to submit feedback, questions, or comments to the host which may be recorded by the system, received via web chat, instant message or e-mail. The questions may then be pre-processed, screened for duplication, and approved by the host prior to broadcast. The system would record the question, if the user is connected by phone, and preferably perform some pre-processing, which may include the removal of lead in silence and other optimizations such as noise reduction and volume stabilization. The question would then be indexed and stored until selected by the host for playback and subsequent response. In an alternate form, the users may be individually designated to have their question or comment broadcast “live” to others in an open forum moderated by the host. Additionally, the host may conduct polls of the audience in order to gather important statistics and obtain overall audience impressions.

During the course of a conference, which began with a specified audience profile, the service may continue to monitor the profile of the connected audience in a further form in order to ensure that the audience profile remains within a specified tolerance range of its predetermined profile. The system may add to or remove users from the conference to adjust the audience profile and maintain compliance with the target audience profile. For example, to combat user attrition and its impact upon the overall audience profile, the system may maintain a number of waiting users which may be immediately added to or activated in the conference to replace a user who disconnects from the conference and has a similar profile. As another example, in the event a user is removed from the conference by the system, the user may be transferred to another ongoing conference or given a reward such as points redeemable for a gift certificate, product sample, or some other item or service of interest in exchange for their participation.

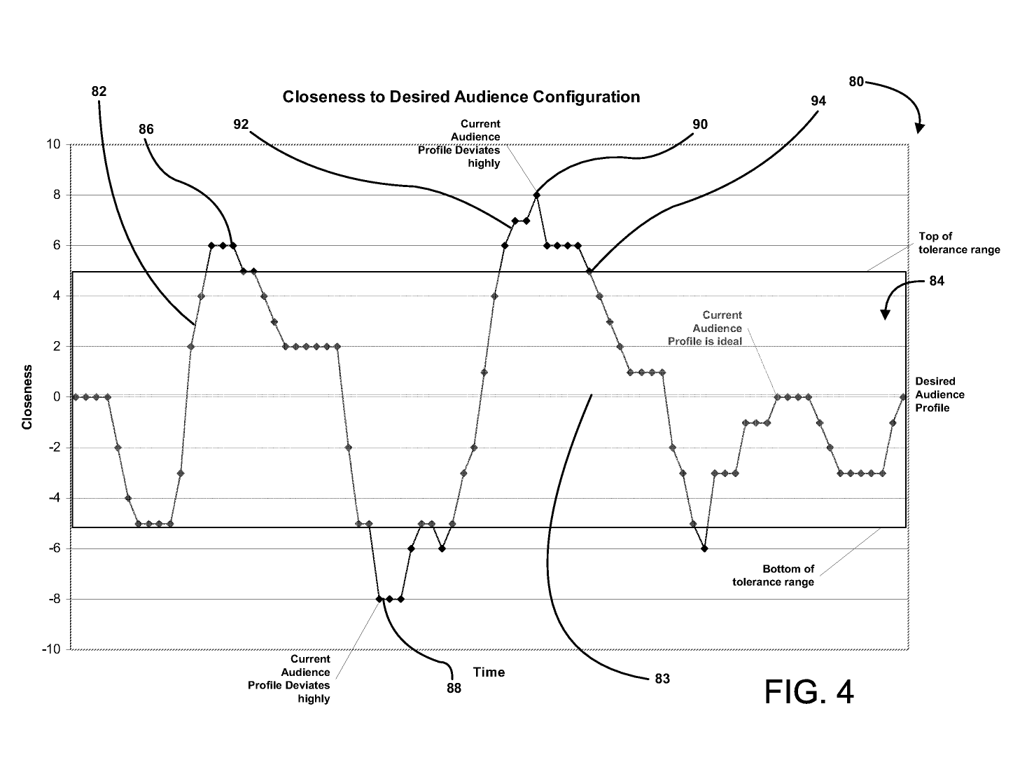

Turning to FIGS. 4-7, a graphical representation of the information utilized by the service for monitoring and correcting the state of the audience profile during the course of a conference is illustrated through a series of examples. FIG. 4 shows a graph 80 which displays the current status of the audience, as indicated by line 82 in relation to the requested profile over time. Horizontal line 82 represents the ideal audience configuration and the acceptable tolerance range is indicated by highlighted field 84. In the illustrative embodiment, the status of the audience profile is illustrated using a multi-dimensional closeness factor, such as a distance formula or a characteristic by characteristic calculation. For purposes of illustration, specific points 86, 88, and 90 represent times when the profile of the currently connected audience deviates too highly from the requested profile. For example, with respect to point 90, it can be seen that the deviation from the desired profile exceeds the allowable tolerance range 84 at point 92. At this point, the service may begin to take corrective action, such as by adding users from the standby queue, removing users, or connecting with additional users. As such, the deviation is corrected and the profile is brought back into an acceptable range as indicated at point 94. In a further form, the service may take preventative action prior to allowing the current profile to exceed tolerances.

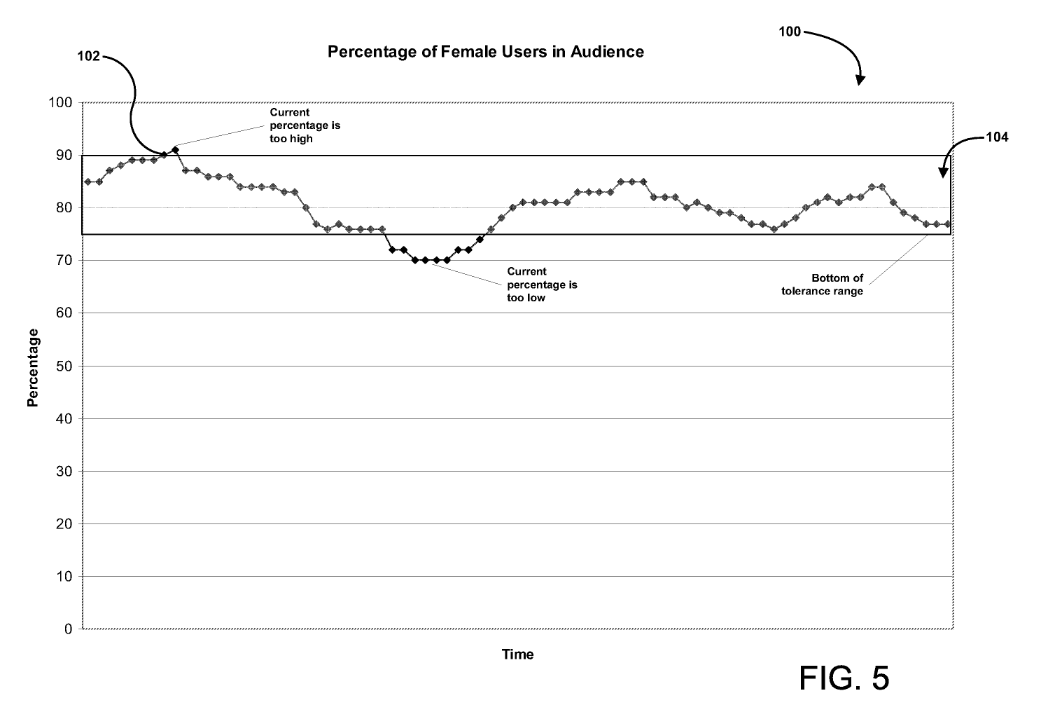

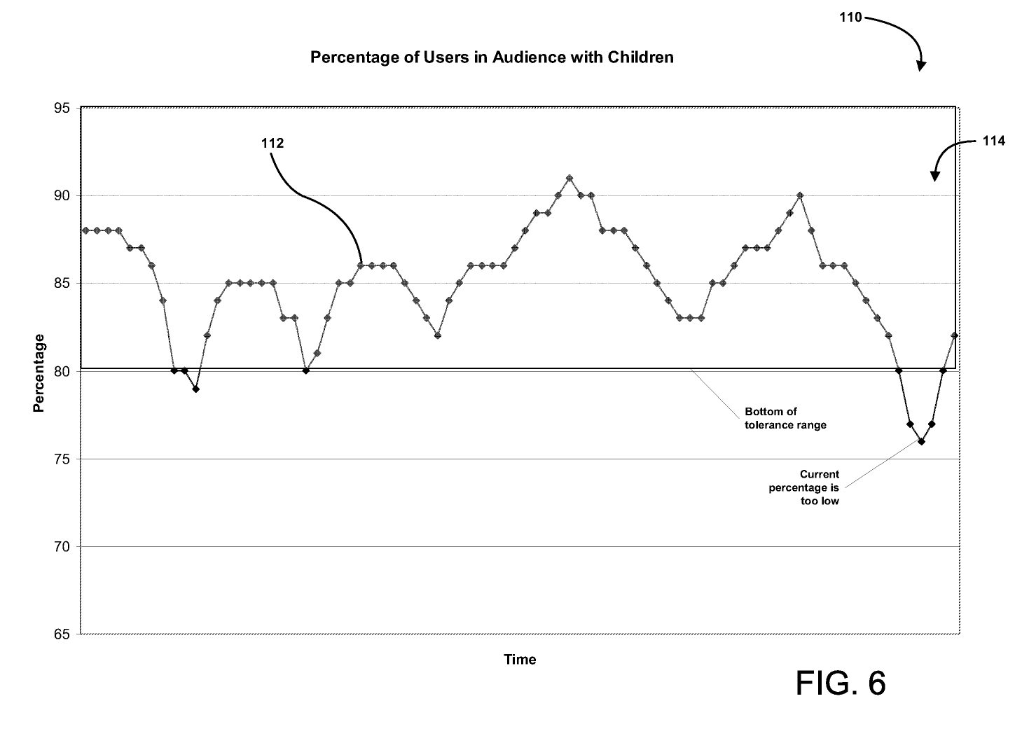

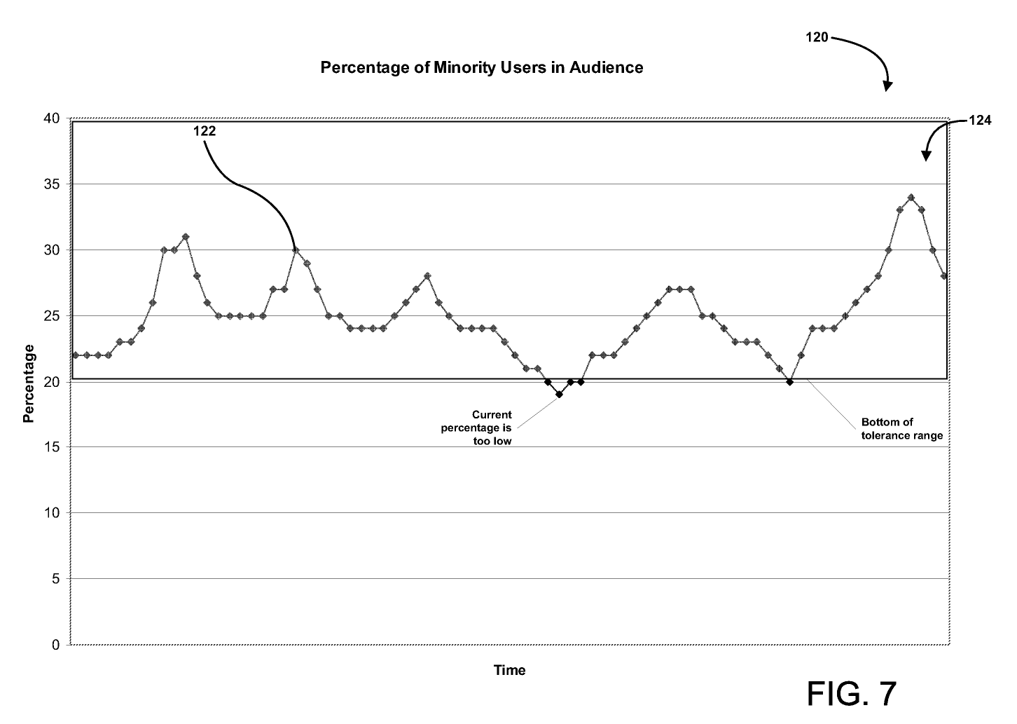

During the course of the conference, the system may display a series of one or more graphs each representing one or more other characteristics of the audience profile, such as to the host or a connected super user, such as a marketing executive or analyst. In the illustrative embodiment, the graphs individually display the conformity of the audience profile to three individual predetermined criteria, such as the percentage of female users, the percentage of users having children, and the percentage of minority users as shown in FIGS. 5-7. Turning to FIG. 5, a graph 100 which displays the current percentage of the audience who are female, as indicated by line 102 is shown. Accompanying the line 102 is a highlighted tolerance range 104 as specified by the host in the requested profile. Moving to FIG. 6, a graph 110 which displays the current percentage of the audience that has children, as indicated by line 112 is shown. Accompanying the line 112 is a highlighted tolerance range 114 as specified by the host in the requested profile. Finally, with respect to FIG. 7, a graph 120 which displays the current percentage of the audience that are minorities, as indicated by line 122 is presented. Accompanying the line 122 is a highlighted tolerance range 124 as specified by the host in the requested profile.

Preferably, the graphs are displayed in near-real time and are useful in allowing the host to monitor the system and its performance in maintaining the requested audience profile. The graphs may also be valuable in determining the actions of a particular group of audience members allowing for further investigation into its cause. For instance, a large number of women near the age of 38-40 may disconnect during the description of a particular new product having a technological twist. This may present valuable information that the product appeals predominately to younger users, or that the product is particularly uninteresting to slightly older women.

While the conference is in progress, the system continuously monitors the compliance of the current audience profile made up of the connected users and responds to a fluctuation of the profile by adding or removing users. Preferably, users are added to the conference from a waiting collection of connected users and have been listening to the conference and providing requested feedback the entire time.

In some forms of conference, such as when a host is conducting a live survey in which users are prompted for responses, the host would like to obtain answers to all questions from an audience having a requested profile. Therefore, if several users are disconnected, in order to maintain compliance, the service needs to connect or remove other users to maintain the profile of the connected audience. In one form several users are connected to the conference but their feedback is not stored with that of those participating in the conference until they are needed, such as when a similar user disconnects. When needed, however, a user's feedback may be included retroactively. For instance, a pool of alternate users may be maintained which may be actively added to the conference in the event of audience attrition.

In another form, the system may respond to a need for additional users having a specific attribute by sending additional invitations to selected users. In a further form, the conference is broken into shorter specific segments, such as individual segments for each product, and the adjustments to the audience are made only at the end of a segment so that the added users are able to hear a complete segment. In a still further form, the host or system may provide annotation throughout the course of the conference to provide context to the statistics when viewed.

In another alternate form, a host may wish to obtain feedback from a plurality of users collectively having a target profile. However, the host may not require that the feedback all be received during the course of a conference. As such, the system may select a plurality of users who collectively meet the requested profile and place an outbound call or e-mail to them asking them to complete a survey or otherwise provide feedback. In another form, an invitation to receive a call may be sent as an e-mail or otherwise. In the event the user indicates his/her willingness to participate, a call may be placed from the service to the user. The service is then able to obtain feedback from a plurality of users with respect to any subject matter provided by the host. The host may record content for playback to a connected user during an outbound call or the host may provide a script which may be played to the user using a text-to-speech algorithm. In the event a call is placed or an invitation is sent and the user fails to provide the requested feedback, the service may select another user meeting the needs of the requested profile and obtain their feedback in order to satisfy the host's request. The feedback received from the user may be traditional survey responses or may be derived from the audio of the user transmitted in response to one or more announcements.

### Content Configuration

In another aspect of the invention, once a number of users are connected, whether they are connected in order to satisfy a requested audience profile or are connected through some other known fashion and the conference begins, the service may also derive and monitor the interest level of the connected users, both individually and collectively, based upon their incoming audio or signals. Therefore, in one form, contrary to traditional conferences, the content of the conference is dynamically adjusted based upon user interest and choices. As such, the service allows the host to engage the connected users and direct the course of the conference based upon their perceived interest level. In one form, the connected users may be instructed to periodically perform an act, such as cheering, booing, pressing a specific key, selecting an on-screen control, or sending a message, to reflect their increased excitement or interest level in response to the conference.

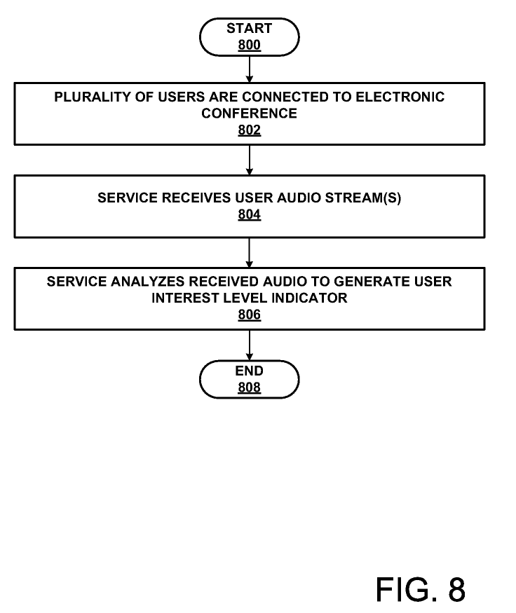

Turning to FIG. 8, the process for assessing user interest level in one aspect of the invention is shown. The process begins are start point 800 with a plurality of the users being connected over audio-enabled devices (stage 802). In one form, the devices are telephones or VoIP enabled computers. The service receives the audio sent from the user (stage 804). Despite this receipt, the user audio may still be selectively muted in the electronic conference. The service then analyzes the audio received to generate an interest level (stage 806). In this stage, the system periodically, or preferably continuously, assesses the interest level of the plurality of connected users by performing an ongoing ambient sound analysis on each respective incoming sound stream. For example, if the system initially detects only silence from an audio stream and subsequently detects a growing level of ambient noise, the system may interpret that as a lack of interest. On the other hand, if the audio stream initially exhibited a large amount of ambient noise and that noise level has since been reduced, the system may interpret this as increasing interest. Additionally, if the system receives a spoken response, loud scream, laughter, or some other vocal expression, the system is able to determine the plurality of users' overall response to a particular segment of the conference, such as an announcement. It shall be appreciated that presently existing audio analysis techniques may be implemented to provide this functionality as will be appreciated by one of skill in the art. In an alternate form, instant messages, e-mails or other forms of communication may be received and processed in order to detect an individual user or audience interest level. The process ends at end point 808, but further steps may be included depending upon the use of the audience level indicator, such as presenting the indicator on a graph showing the indicator correlated to the substance of the content presented.

Turing to a brief example of the audience interest level indicators use, such as a teleconference between a popular musical artist and her fan club, the response to an announcement of a new board game sponsored by the singer may indicate only a marginal percentage of users were excited by expressing their excitement vocally. To the contrary, if the singer were to announce the release of a new clothing line, the vocal response may be somewhat overwhelming.

In yet a further form, the system may allow for a subset of the connected users, such as a group of users from the organizing entity, to be connected to the conference and have the statistics obtained by the system passed along to them as well, such as at a web site for concurrent viewing and tracking of the conference. Thereby, the organizer, or sponsor of the conference could effectively participate in the monitoring of the conference as well as view valuable information from an audience concerning its products, services, or potential offerings, much like a traditional focus group.

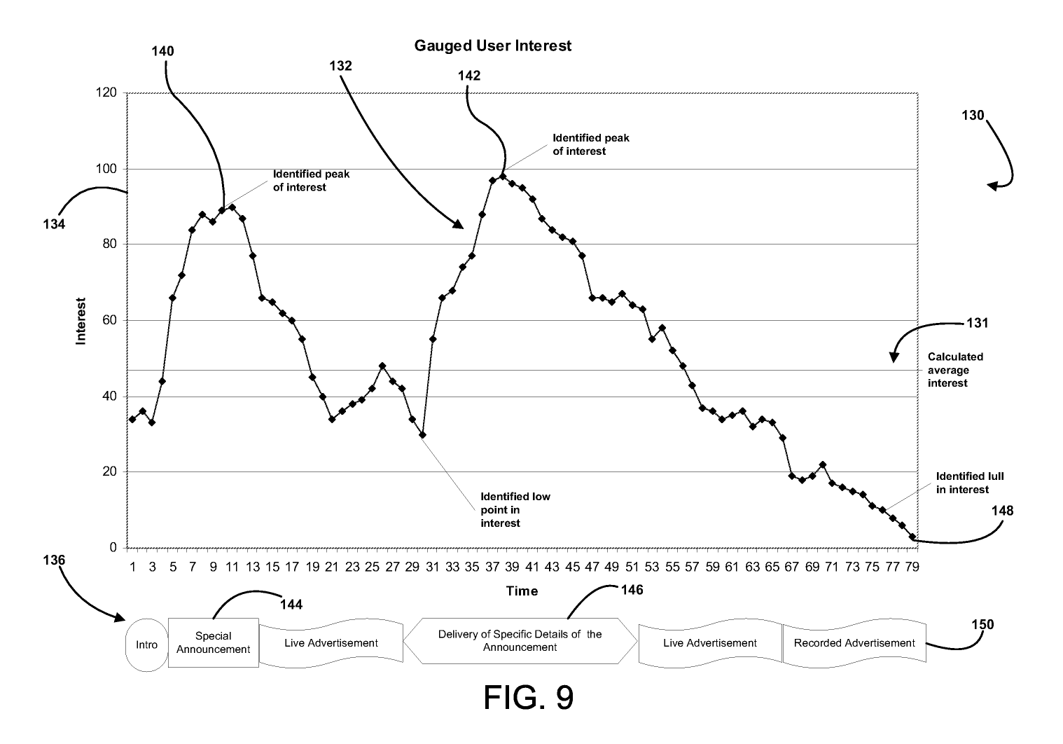

Turning to FIG. 9, a graph 130 representing one illustrative example of the statistics provided by the monitoring component of the system is illustrated. In this particular embodiment, the graph 130 shows the gauged user interest level 132 as a percentage of the accessible users 134. Additionally, the flowchart 136 beneath the graph shows the content of the conference as observed by the users. The two vertically correspond in that the interest of the users can be seen at any time, and similarly, the general subject of the conference at that exact time can be seen below. The two identified peaks in the graph (indicated generally by 140 and 142) represent when the users were identified by the system as having a proportionately high interest level. As can be determined, the users' interest peaked during the “Special Announcement,” (144) which may be the announcement that the guest singer will be launching a worldwide tour and again during the delivery of the “Specific Details of the Announcement,” (146) which may include the various dates and venues of the tour. In turn, the low level represents when the users were, for the most part, determined to be disinterested, in this case point 148, near the end of an inserted recorded advertisement 150. For control purposes, the graph also displays the average level of user interest over the duration of the conference as a horizontal line 131. This enables the host to identify when a particular topic is likely to be no longer worthwhile, or alternatively, when another topic is gaining favorable acceptance. In a further form, the graph may provide several lines, bars, or surfaces, which may be color coded, to simultaneously or individually display the collected interest statistics of one or more subsets of the users, such as a subset based upon sex, age group, or another demographic descriptor or characteristic.

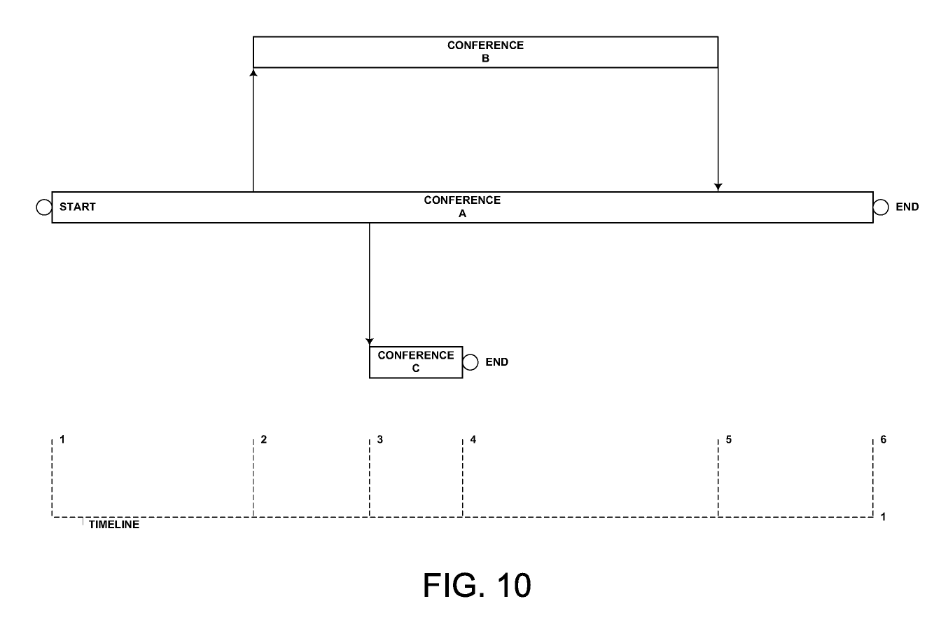

In a further embodiment the system may be configured to provide multiple hosting stations so that one or more organizers may designate two or more hosts to collaborate in order to provide a customized sequential procession of differing content, potentially facilitated by different hosts, to selected subsets of the connected users based upon interest level. One example of a procession of a conference according to this embodiment is illustrated in FIG. 10. FIG. 10 shows the chronological procession of a set of associated conferences and an associated timeline below for reference. The initial conference (conference A) is initiated at time 1. In this illustrative embodiment, at start point 1, a first host is connected with all of the initially connected users in a single conference. After initiation, the host may provide a welcome message, an overview of the topic(s) of the rest of the conference or some other introductory information. For purposes of example, the host may provide an introduction and welcome a popular singer as his/her guest. Based upon some indication from the information collected from the users, such as their perceived interest levels, at time 2, the conference is divided into two or more conferences, with a group of currently connected users assigned to each conference. In the illustrative example, a group of users is dynamically identified as having a differing or lowered interest, and as a result are connected to a new conference (conference B) with a new host which will present a potentially more interesting topic. For example, one set of users may not be interested in an upcoming televised concert, and therefore they may be divided into a conference which describes an upcoming concert in their area. If desired, the guest may have previously recorded this segment of the conference to facilitate the simultaneous presentation of different information by the same host in more than one conference. Otherwise, the other conferences may be connected to a different host with an entirely distinct guest. As the division is made, the original conference (conference A) continues, with a reduced group of connected users, under the original host. The division into two separate conferences is completely transparent to the users connected to each.

Once the split is complete, Conference A proceeds to time 3 and again identifies a group of connected users whose interests are not in line with those desired by the organizer. For example, the user may simply be not showing any interest in the subject matter or may not be participating in the surveys. As a result, the host again divides the conference into two separate conferences. In this instance, Conference A continues on, while the users transferred to Conference C are presented with a recording or live host which thanks them for their participation, potentially provides some information, compensation, reward, or other salutation and disconnects the users thereby ending Conference C at time 4.

Returning to Conference A and Conference B, they continue to proceed under the individual direction of their respective hosts. In this example, at time 5, a need to reconvene the two distinct groups of connected users exists. For example, the original host of Conference A may have a major announcement to make, which is likely to appeal to any connected user, no matter what their course through the conference has been to this point. Therefore, the hosts are able to reconnect the users of Conference B to Conference A. The remainder of the conference may proceed until further divisions or unifications are needed, or the conference ends at time 6. It shall be appreciated that a conference may be divided into any number of smaller conferences or combined into a larger conference at any time. In addition, a conference may be divided a first time and subsequently divided again, allowing for the organizer and hosts to have complete control over the group of users which are connected to a variety of conferences which are created as branches of an original conference or conferences. Other examples of the criteria used by the hosts in making branching/unification decision may be the statistics presented concerning a particular user's interest level, the survey responses of a user, prior historical information known about a user, demographic information, or any other information available to the system.

In another form, additional hosts may operate at stations to provide live advertising content which may be selectively incorporated into the conference of selected users, such as by way of targeted marketing. In one example, a popular soda company may act as one sponsor of the conference and have a host of their own using the system to facilitate a contest or promotion where the users may win products and/or prizes. Additionally, a make-up company may also operate a station with a similar promotion. Then, upon selection by the host of the entire conference, a user could be dynamically connected to the conference of the advertiser which most meets their marketing demographic to facilitate targeted live advertising.

### User Branching

In yet another aspect of the present invention, the service allows a host to offer connection services to several entities of interest, such as by telephone, voicemail, or e-mail, to each individual user. In a further form, the contact information of an entity of interest may be dynamically determined, such as by using known information about the user, such as the 9 digit zip code of the user. When combined with a collection of large users, such as in the case of an electronic conference, a large and motivated contact or calling force may be assembled to ensure that the views of a group are heard.

The service allows a host to initiate a communication session with a user such as an e-mail, instant message, telephone call, conference, virtual meeting, which all are commonly known to one of skill in the art. The inventive concepts of the present disclosure shall be illustrated as incorporated within a teleconferencing service; however, it shall be appreciated that their application to other forms of communication is contemplated.

In the illustrated embodiment, the service is configured to provide connection services to a plurality of users allowing them to quickly reach entities of interest, such as in support of a cause. For example, an organizer such as the animal rights group PETA, may host a conference having a special guest who is a popular animal rights activist, and the connected users are PETA members and supporters. In this embodiment, the user may be prompted to deliver a message to an entity of interest, such as a popular advertising company, and upon acceptance the user may be directly connected to that entity via telephone. In another form, the user may dictate the body of an e-mail which will be captured using voice recognition techniques by the system and forwarded on to the entity of interest on their behalf. In one form, such as when different users should contact different entities depending upon criteria, such as their geographic location, the contact information for the appropriate entity or office of the entity corresponding to the user, such as one or both of the user's Senators, is dynamically looked up in the collection of contact listings stored in the data store 34 of FIG. 1. In this embodiment, the contact listings are telephone numbers, which may be acquired and stored in the data store prior to the conference. In other embodiments, the contact listings may include e-mail addresses, screen names, or some other form of contact address known to one of skill in the art.

In the illustrated embodiment, when the user expresses a desire to be connected to an entity of interest, the contact information stored by the system and a set of rules are used to determine the proper contact listing. The selected listing corresponds to the selected entity of interest that the user will be connected to based upon their previously provided user information. In the present embodiment, the rules determine the user's proper U.S. Senators or Congressmen based upon their state of residence or 9 digit zip code. In other forms, the system could be configured to determine a user's local police office, local branch or office of a major corporation, charity, chapter, group, state representative, governor, mayor, or any other entity of interest having readily obtainable or provided contact information.

Additionally, the system may connect the users individually to the various entities of interest and remain a party to the communication for the collection of statistics such as call success rate. In the case of telephone connection, if the entity of interest is not available, the system may continue to attempt to connect the user, may record a message from the user and subsequently deliver it to the entity of interest, or may dial the user at a later time for connection when the entity of interest is available. Once a user has been connected to an entity or has recorded a message for subsequent delivery the user may be returned to the conference and invited to make further communications to other contacts.

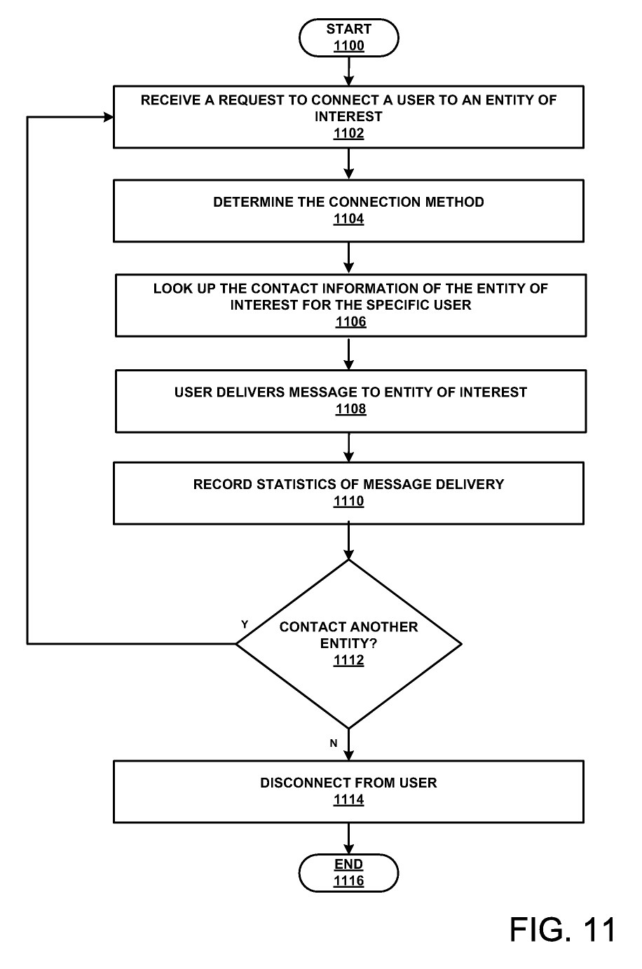

Turning to FIG. 11, the process for connecting a user to an entity of interest is illustrated. The process begins at start point 1100 with the service receiving a request to connect a user to an entity of interest (stage 1102). In one form, the request is sent as a DTMF tone or vocal response from a user in response to a prompt from the service. The service then determines which method of connection to use between the user and the entity of interest (stage 1104). Various methods of connection may include telephonic connection, voice mail, e-mail, or other available connection methods. The connection method may be set by the host, selected by the user, or selected by the system based upon available methods of contact for the entity of interest. Once the method of contact is established, the service dynamically determines the proper contact information, such as the proper phone number or e-mail address of the entity of interest, for the current user (stage 1106). As described above, this information may be retrieved based upon the user's geographic location, zip code, telephone number, or any other information stored in by the service. The user is then connected to the entity of interest and their message is delivered (stage 1108). In one form, this step involves the service placing an outgoing call with Gateway Server 26 of FIG. 1 and connecting the outgoing line with that of the current user. In an alternate form, the user may record a voicemail or dictate an e-mail to the service which is then created and sent to the entity of interest through appropriate means.

Once the user has delivered the message to the entity of interest, the service may record statistics (stage 1110), such as for use by or presentation to the host, which may indicate the number of entities contacted and the types of messages sent. Additionally, the connected user may contact additional entities, such as selected from a list provided by the service (stage 1112). If the connected user wishes to contact another entity, the process return to stage 1102 and the process begins again. In the event the user is complete, then the user may be disconnected after an exit message is played or the user may be returned to an ongoing conference (stage 1114). The process then ends at end point 1116.

Once the conference and any call branching is completed, in one form, the users are thanked for their participation and may be awarded monetary compensation or some other incentive such as product samples, valuable coupons, gift certificates, or loyalty points which may be redeemable for valuable gifts, products, or services. In another form, the entire conference, including the statistics and annotations collected by the system may be archived and played back to an interested party, allowing still further information collection and analysis.

The disclosed system is capable of establishing a trusted and dependable resource of a large collection of participants suitable for use by a variety of hosts. Other hosts may include political parties, radio stations, celebrities, film producers, athletes, software companies, auto manufacturers, and marketing firms to name just a few representative examples.

Further, by using the information stored and an optional incentive based loyalty program, the system can dynamically create an audience to meet any host's demands and ensure that the audience requested will remain active throughout the course of the conference. The system uniquely and efficiently connects a host, who is desirous of valuable information from a select group, with users who collectively make up the group that the host designates, and provides an incentive to both parties.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for connecting to an audience having a predetermined profile comprising the steps of:
storing a plurality of user profiles representing a plurality of users, each user profile containing contact information and identifying information regarding an associated user;
receiving a target profile, said target profile including at least one audience characteristic other than total quantity; and
connecting to a subset of said plurality of users in at least one telecommunication session such that an audience profile calculated as a function of the plurality of user profiles representing said subset satisfies said target profile.

2. The method of claim 1, wherein said contact information includes a telephone number.

3. The method of claim 2, wherein said at least one telecommunication session is a teleconference.

4. The method of claim 2, wherein each user within said subset is connected to in an individual telecommunication session.

5. The method of claim 3, wherein said connecting includes placing an outbound call to each user within said subset and subsequently activating the user within said teleconference.

6. The method of claim 4, wherein said connecting includes placing an outbound call to each user within said subset.

7. The method of claim 1, wherein said telecommunication session is a web chat session.

8. The method of claim 1, wherein said identifying information includes demographic information.

9. The method of claim 8, wherein said audience characteristic is a demographic characteristic.

10. The method of claim 9, wherein said demographic characteristic is expressed as either a quantity or a percentage.

11. The method of claim 9, wherein said demographic characteristic is provided as a minimum or maximum.

12. The method of claim 9, wherein said demographic characteristic is provided as a range having a maximum and a minimum.

13. The method of claim 10, wherein said demographic characteristic is selected from the group consisting of age, sex, income, and race.

14. The method of claim 12, wherein said demographic characteristic is selected from the group consisting of age, sex, income, and race.

15. The method of claim 9, wherein said target profile includes at least two demographic characteristics.

16. The method of claim 15, wherein said electronic conference is a teleconference.

17. The method of claim 15, wherein said target profile includes at least three demographic characteristics.

18. The method of claim 14, wherein said target profile includes at least three demographic characteristics.

19. The method of claim 1, wherein said identifying information includes purchase history information.

20. The method of claim 1, wherein said audience characteristic indicated whether a user has used a particular product or service.

21. The method of claim 3, further comprising the step of:
prompting said subset with a feedback request within said at least one telecommunication session; and
receiving feedback from said subset during said telecommunication session such that an audience profile calculated as a function of the plurality of user profiles representing said subset satisfies said target profile.

22. The method of claim 21, wherein said feedback request is a survey question.

23. The method of claim 22, wherein said feedback request is a recorded voice message.

24. The method of claim 21, wherein said receiving includes receiving a DTMF tone.

25. The method of claim 21, wherein said feedback is derived from the audio received from the user.

26. The method of claim 4, further comprising the step of:
prompting each user within said subset with a feedback request within the associated individual telecommunication session; and
receiving feedback from each user within said subset during the associated individual telecommunication session such that an audience profile calculated as a function of the plurality of user profiles representing said subset satisfies said target profile.

27. The method of claim 26, wherein said feedback request is a recorded voice message.

28. The method of claim 26, wherein said feedback is derived from the audio received from the user.

29. A method for maintaining an audience of users connected to an electronic conference in compliance with a predetermined profile comprising the steps of:
maintaining a plurality of user profiles, each user profile containing contact information and identifying information regarding an associated user;
receiving a target profile from a conference host, said target profile including at least one audience characteristic other than total quantity;
determining that an audience of users connected in an electronic conference no longer meets said audience characteristic;
identifying a second plurality of users, based upon said plurality of user profiles, such that said audience of users and said second plurality of users satisfies said target profile; and
connecting said second plurality of users to said electronic conference.

30. The method of claim 29, wherein said electronic conference is a teleconference.

31. The method of claim 30, wherein said contact information includes a telephone number.

32. The method of claim 30, wherein said connecting includes placing an outbound call to said subset.

33.-45. (canceled)

46. A method for collecting feedback and maintaining an audience of users connected to an electronic conference in compliance with a predetermined profile comprising the steps of:
receiving a target profile from a conference host, said target profile including at least one audience characteristic other than total quantity;
selecting a first plurality of users such that said first plurality of users collectively satisfy said target profile;
selecting a second plurality of users;
connecting said first plurality and said second plurality of users to said electronic conference;
storing feedback in a first memory received from said first and second plurality of users in response to prompts presented in said electronic conference;
storing feedback in a second memory received from said first and second plurality of users in response to prompts presented in said electronic conference;
determining that a user within said first plurality of users has disconnected from said electronic conference;
identifying a subset of said second plurality of users such that said first plurality of users and said subset collectively satisfies said target profile;
removing the feedback received from said first user from said first memory; and
storing the feedback received from said subset in said first memory.

47.-71. (canceled)
